(19) United States
(12) Patent Application Publication
(10) Pub. No.: US 2021/0270143 A1
(43) Pub. Date: Sep. 2, 2021

(54) Electricity generating tiles using micro-turbines for air and water

(71) Applicant: Mirza Faizan, Irving, TX (US)

(72) Inventors: Mirza Faizan, Irving, TX (US); Mirza Rizwan, Patna (IN); Aamenah Saeed, Plano, TX (US); Bilal Syed Ali Shah, Murphy, TX (US); Mehreen Afreen Syed, Murphy, TX (US); Omar Aamir Memon, Richardson, TX (US); Rania Azeez, Plano, TX (US); Yahya Siddiqui, Murphy, TX (US); Zain Khan, Murphy, TX (US)

(21) Appl. No.: 17/185,049

(22) Filed: Feb. 25, 2021

Related U.S. Application Data
(60) Provisional application No. 62/982,620, filed on Feb. 27, 2020.

(51) Int. Cl. F01D 15/10

(52) U.S. Cl. CPC F01D 15/10; F05D 2250/82

(57) ABSTRACT

A machine and system for power generation through the air, water, sunlight, noise, and movement having an array of power generating microturbine bricks electrically interconnected, where the array is configured in an interchangeable modular fashion and the bricks are positioned to receive energy from the movement of air, water, etc. to generate electricity through the movement of an electrical turbine within each brick. The present invention enables the effective utilization of natural resources, which will help to promote the use of such energy.

### TECHNICAL FIELD

The present invention relates generally to the field of power generation systems and more specifically the invention relates to generating electricity by using natural resources and wirelessly charging electric cars.

### BACKGROUND OF THE INVENTION

With the growth of large cities, industrialization, and modern living, the energy demand has increased. One way the world is currently meeting this ever-rising demand is by using nuclear power to generate electricity. Nuclear power, while providing us abundant energy comes with a big tradeoff, the risk of nuclear disaster. We have seen many instances of a nuclear power plant disaster in the recent world. One of the biggest challenges in the world today is generating clean energy. We observed that while the world is looking for ways to generate clean energy, there are so many sources of energy around us that can be harvested, for example, air, water, and even the movement of vehicles.

Centralized power distribution can have a major impact on communities when the distribution system is taken down either from natural or man-made disasters. Solar panel production can provide some amount of power if the distribution system goes down. However, clouds frequently block the collection of energy to allow solar panel energy production. Solar panels also stop power generation during the night time hours.

One potential solution is large commercial-grade wind turbines that generate significant amounts of power. However, these large commercial grade generators must be located away from the consumers. Distribution and transmission systems are required to move the power from the large commercial generation facility to the consumers. Large commercial-grade wind turbines cannot operate in high wind conditions due to the inertia generated by the large turbine blades.

The extraction of energy from water sources has been a desire of humankind for ages. Various methods involve water wheels, entrainment, and hydroelectric turbines. Prior attempts to convert ocean tidal movements or current into power involve large scale systems, the use of traditional generators, and various turbines to capture the power of the water. The deficiency in the prior art is that the systems are not easily configurable for different settings, require large-scale construction, and are not commercially viable. They are not suitable for being moved easily, they are not topographically adaptable, nor do they withstand the corrosive effects of water. Further, the weight needed for a traditional generator having magnets and copper wire inhibits replacement.

We also have learned to generate electricity from wind energy however, such wind energy plants can only be established in remote locations owing to their large size. Similarly, we can also generate electricity from a hydro-electric power plant, which can only be installed over large dams, thus seriously limiting our capability to harness water energy. A system is needed which harness wind and water energy anywhere in the world, without any limitations.

With depleting oil and natural gas, we have started using electric cars. However, one big challenge in using an electric car is its limited range due to battery capacity. Another disadvantage is the long charging time for these car batteries.

All of these conventional methods/systems or a computer program product, and some other method/system presently known in the art have had some flaws in design or mechanism and lacks precision. Most of the existing systems are too expensive and time consuming to be practical for most users. Some shortfalls of the existing method/apparatus or a power generation system include man-made disasters. In light of this, there is a need for a method/apparatus or a power generation system that overcomes these constraints.

Further, there is also a need for a power generation system that facilitates electricity generation, in particular, wind and water energy generation anywhere in the world by only using natural resources that would facilitate the wireless charging of electric cars, without any limitations.

None of the above inventions and patents, taken either singly or in combination, is seen to describe the present invention as claimed. Thus, a system having the ability to harness wind and water energy anywhere in the world, without any limitations solving the aforementioned problems is desired.

Features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

The present invention addresses the issues as discussed above.

### SUMMARY OF THE INVENTION

The object of the present invention is to overcome the disadvantages of the prior arts and provide a power generation system for generating electricity by using natural resources such as air, water, sunlight, noise, etc, anywhere in the world that would facilitate wireless charging of electric cars, without any limitations. A turbine fan will rotate independently inside a Microturbine Brick (MTB) to extract additional energy from natural resources. These turbines installed inside a Microturbine Brick (MTB) will be micro in size.

It is another object of the present invention to provide a modular design of the micro wind turbine to allow multiple wind turbines to be connected, if desired, with hook-cum-electric connectors in a chain of micro wind turbines behind one another to form a chain configuration. At the end of this grid, a battery will be placed. This design allows the battery to be placed in and around any structure near the power consumption needs. There are also pluralities of wireless or induction charging strips on the surface of the said brick to wirelessly charge electric cars.

It is another object of the present invention to provide a Microturbine Brick (MTB) that will be a unique innovation that harnesses the power of natural resources such as air, water, sunlight, noise, and movement to generate electrical energy. This brick may be used in the construction of buildings and roads to generate electricity from rain, wind, sunlight, and air turbulence created by the weather or movement of vehicles.

It is another object of the present invention to provide the construction brick used in infrastructures such as roads and buildings to take advantage of the energy trapped in the rain, thunderstorms, sunlight, noise, the air currents generated by automobiles, and more to generate energy.

It is another object of the present invention to facilitate power generation through the air, water, sunlight and noise having an array of power generating Microturbine Bricks (MTB) that are interconnected, where the array is composed of bricks in an interchangeable modular arrangement and the bricks are positioned to receive kinetic energy from the movement of air or water, wherein the bricks convert energy by the movement of an electrical turbine within each brick.

It is another object of the present invention to extract electrical energy from moving water (wave, current, rains, tidal, or other). The Microturbine Brick (MTB) contains windings made of copper or a conductive polymer or other conductive material. Rotating magnetic field produced from a magneto polymer, particulate materials that generate a magnetic field suspended in a homogeneous or heterogeneous polymer or traditional magnetic material such as Fe, Co—Ni, Gd, Sn, Nd or ceramics that exhibit magnetic fields generates electrical energy as the independent turbine containing the magnetic material passes by the conductive windings.

It is another object of the present invention to provide generation of electrical energy from the air, for example, strong winds. The energy is transferred from one brick comprising of a turbine to the next via the hook-cum-electric connectors until it can be transferred to a collection system. Wherein, the collection system is a battery at the end of the grid. Additionally, the array's modular design allows for repairs and maintenance of the turbines without taking the entire power generating capacity of the array offline.

It is another object of the present invention to provide a system made up of polymer, ceramic, or nonferrous coated metal, and any potentially magnetic part internal to the turbine does not contact the water directly, it does not corrode. Hence, it is lightweight, it is portable, it is cheap to manufacture and replace, and topographically configurable.

It is another object of the present invention to provide solar panels on top of the Microturbine Bricks (MTB) to facilitate solar power generation. This will provide a solar power generation apparatus capable of properly monitoring operation even when a commercial power supply is out of order.

It is another object of the present invention to gather all this energy and convert it into electricity. This electricity is then stored in large underground batteries. The brick also had in-built wireless induction charges which can charge an electric car while it is running. Only the surface of buildings or the top of roads will be covered in brick. This makes the brick fit in well with the existing infrastructure system. Pre-existing roads can be covered with brick, and construction teams looking to utilize this brick for houses or office buildings will not have to make substantial changes to their architectural plans.

In an embodiment of the present invention, a power generating brick for power generation said brick comprising: a plurality of air and water intake slots on the first face of each of said bricks (12); a plurality of microturbines (11) configured to rotate based on air and water intake by the air and water intake slots; a plurality of turbine axel rods to which the plurality of microturbines (11) are connected; a plurality of hook-cum-electric connectors (13, 14) to connect a plurality of the bricks from side face; and a plurality of wireless or induction charging strips 17 on the surface of the brick, wherein the wireless or induction charging strips 17 get charged based on the output of rotation of the plurality of microturbines in the plurality of connected bricks.

Other objects, advantages, and features of this invention will become more apparent from the following description.

The details of one or more implementations are set forth in the accompanying description below. Other aspects, features, and advantages of the subject matter disclosed herein will be apparent from the description and the claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

Features, elements, and aspects of the invention that are referenced by the same numerals in different figures represent the same, equivalent, or similar features, elements, or aspects in accordance with one or more embodiments.

The following figure depicts a certain illustrative embodiment of the invention. This depicted embodiment is to be understood as illustrative of the invention and not as limiting in any way.

Referring particularly to the drawing for the purpose of illustration only and not limitation, there is illustrated:

FIG. 1 shows various components of the micro-turbine brick as according to the present invention.

### DRAWINGS—REFERENCE NUMERALS

10 Micro Turbine Brick
11 Series and layers of microturbine
12 Air and water intake slot
13 Hook-cum-electric connector
14 Hook-cum-electric connector
15 Wall-cum-road hook
16 Wall-cum-road hook operation switch
17 Wireless/Induction Charging strip
18 Battery
19 Solar Panels

### DETAILED DESCRIPTION OF DRAWINGS

Detailed descriptions of the preferred embodiment are provided herein. It is to be understood, however, that the present invention may be embodied in various forms. Therefore, specific details disclosed herein are not to be interpreted as limiting, but rather as a representative basis for teaching one skilled in the art to employ the present invention in virtually any appropriately detailed system, structure, or manner.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

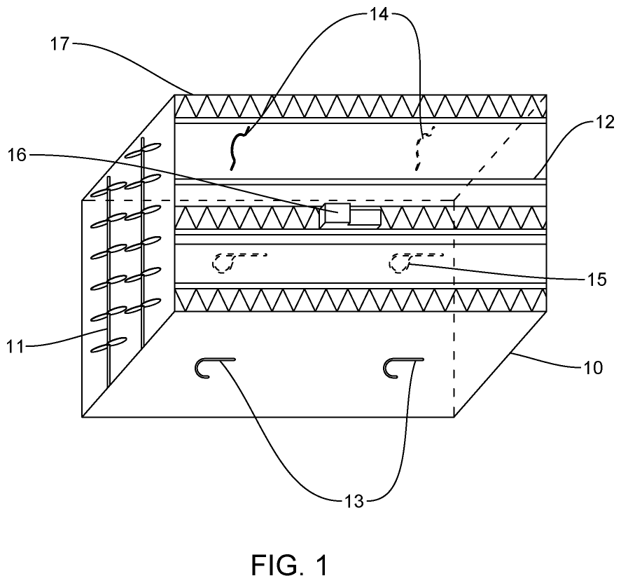

FIG. 1 shows an overall view of the Microturbine Brick 10 which is made up of a strong material hollow frame. Under the frame, there are series and layers of micro-turbines 11. Said microturbines are connected to turbine axel rods. On the top of the said brick, there are pluralities of air and water intake slots 12. On either side of the said brick, there are hook-cum-electric connectors 13 and 14. There is also a wall-cum-road hook 15 at the bottom layer of each brick. On the top of said brick, there is a wall-cum-road hook operation switch 16. There is a plurality of wireless or induction charging strips 17 on the surface of the said brick.

According to another object of the present invention, energy is transferred from one brick comprising of a turbine to the next via the hook-cum-electric connectors 13,14 until it can be transferred to a collection system. Wherein, the collection system is a battery at the end of the grid. Additionally, the array's modular design allows for repairs and maintenance of the turbines without taking the entire power generating capacity of the array offline.

According to another object of the present invention, wherein solar panels are placed on top of the brick to facilitate solar power generation. This will provide a solar power generation apparatus capable of properly monitoring operation even when a commercial power supply is out of order.

According to an embodiment of the invention, the Microturbine Brick 10 produces energy from moving water (wave, current, rains, tidal, or other). The Gulf Stream in the Atlantic Ocean and Kuroshio Current in the Pacific Ocean provide examples of steady deepwater current that the present invention could utilize to drive a plurality of bricks arrayed as further described herein. However, in a deepwater zone, it is difficult to harness the water power and maintain an array of power generating bricks. In contrast, the water movement in a breakwater zone, a non-electrified reservoir, a river, or an aqueduct are more amenable to the advantages and benefits of the current invention.

In another embodiment, the Microturbine Brick 10 provides the generation of electrical energy from the air, for example, strong winds. The Microturbine Brick 10 is made up of a strong material hollow outer frame. Under the frame, there are series and layers of micro-turbines 11 which are rotated by air, water, and air turbulences created by moving vehicles on road and generate electricity. Said microturbines are connected to turbine axel rods which serve as a conductor of generated electricity which is stored in an underground large battery.

In another embodiment, Microturbine Brick 10 provides the generation of electrical energy from solar panels. The solar heat-absorbing solar panels for absorbing solar heat can be placed on top of the Microturbine Bricks (MTB) to facilitate solar power generation. This method can effectively utilize solar thermal power, a simple, solar thermal power generation system capable of downsizing, independent, portable devices, and would further promote the use of solar energy. Furthermore, it would provide a solar power generation apparatus capable of properly monitoring operation even when a commercial power supply is out of order.

As shown in FIG. 1, micro-turbine brick 10 is made up of the strong material hollow outer frame. Under the frame, there are series and layers of micro-turbines 11 which are rotated by air, water, and air turbulences created by moving vehicles on road and generate electricity. Said microturbines are connected to turbine axel rods which serve as a conductor of generated electricity which is stored in an underground large battery. On the top of the said brick, there is a plurality of air and water intake slots 12 which are designed to intake rainwater or air inside. On either side of the said brick, we have hook-cum-electric connectors 13 and 14 which are used to hook the said brick to its adjacent brick, so that these bricks may be paved on any flat surface by connecting them through these hooks. There is also a wall-cum-road hook 15 at the bottom layer of each brick which is used to hook on the said bricks onto the flat surface and make sure it stays in its location even when heavy vehicles pass over it and they apply brakes. On the top of said brick, there is a wall-cum-road hook operation switch 16. The said operation switch is used to open and close the hook and remove the brick from its position. There is a plurality of wireless or induction charging strips 17 on the surface of the said brick. Said charging strips may wirelessly charge a moving electric car, leading to a limitless range of battery-powered cars.

It is recognized, however, that departures may be made within the scope of the invention and that obvious modification will occur to a person skilled in the art. With respect to the above description then, it is to be realized that the optimum dimensional relationships for the parts of the invention, to include variations in size, materials, shape, form, function, and manner of operation, assembly, and use, are deemed readily apparent and obvious to one skilled in the art, and all equivalent relationships to those illustrated in the drawings and described in the specification are intended to be encompassed by the present invention.

It is therefore submitted that the instant invention has been shown and described in what is considered to be the most practical and preferred embodiments. It is recognized, however, that departures may be made within the scope of the invention and that obvious modification will occur to a person skilled in the art. With respect to the above description then, it is to be realized that the optimum dimensional relationships for the parts of the invention, to include variations in size, materials, shape, form, function, and manner of operation, assembly, and use, are deemed readily apparent and obvious to one skilled in the art, and all equivalent relationships to those illustrated in the drawings and described in the specification are intended to be encompassed by the present invention.

It is noted that various connections are set forth between elements in the description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

While in the foregoing specification, several embodiments of the invention have been set forth for purposes of making a complete disclosure, it will be apparent to those skilled in the art that numerous changes may be made without departing from the spirit and principles of the invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Although the present invention has been explained in relation to its some embodiments, it is to be understood that many other possible modifications and variations can be made without departing from the Spirit and Scope of the invention as hereinafter claimed.

What is claimed is:

1. A brick for power generation said brick comprising:
a plurality of air and water intake slots on first face of each of said bricks (12);
a plurality of microturbines (11) configured to rotate based on air and water intake by said air and water intake slots;
a plurality of turbine axel rods to which said plurality of microturbines (11) are connected;
a plurality of hook-cum-electric connectors (13, 14) to connect a plurality of said bricks from side face; and
a plurality of wireless or induction charging strips (17) on the surface of the said brick, wherein said wireless or induction charging strips (17) gets charged based on an output of rotation of said plurality of microturbines in said plurality of connected bricks.

2. The power generating brick for power generation as claimed in claim 1 further comprising a wall-cum-road hook operation switch 16 configured to open and close the hook and remove the brick from its position.

3. The power generating brick for power generation as claimed in claim 1 further comprising a wall-cum-road hook 15 at the bottom layer of each brick configured to hook the said bricks onto the flat surface.

4. A system for power generation through the air, water, sunlight, noise, and movement comprising: an array of microturbine bricks electrically interconnected; said array composed of said bricks in an interchangeable modular arrangement; said bricks are positioned to receive energy from the movement of air, water, etc. wherein said bricks convert said energy by the movement of an electrical turbine within each brick.

5. A system for power generation through the movement of water as claimed in claim 4.

6. A machine for power generation through the movement of air as claimed in claim 4 wherein said micro turbine bricks are electrically interconnected to the electrical grid through hook-cum-electric connectors in a chain.
